(19) United States
(12) Patent Application Publication
(10) Pub. No.: US 2025/0315958 A1
(43) Pub. Date: Oct. 9, 2025

(54) Object Recognition Apparatus and Object Recognition Method

(71) Applicants: Hyundai Motor Company, Seoul (KR); Kia Corporation, Seoul (KR)

(72) Inventor: Ji Hee Han, Hwaseong-si (KR)

(21) Appl. No.: 18/920,258

(22) Filed: Oct. 18, 2024

(30) Foreign Application Priority Data
Apr. 3, 2024 (KR) 10-2024-0045436

(51) Int. Cl. G06T 7/215; B60W 30/00; B60W 50/14; B60W 60/00; G06T 7/246; G06T 19/00; G06V 10/766; G06V 10/77; G06V 20/58

(52) U.S. Cl. CPC G06T 7/215; G06T 7/248; G06T 19/00; G06V 10/766; G06V 10/7715; G06V 20/58; B60W 30/00; B60W 50/14; B60W 2050/146; B60W 60/00; B60W 2420/403; B60W 2420/408; B60W 2554/4044; G06T 2207/20081; G06T 2207/30261; G06T 2210/12; G06T 2219/028

(57) ABSTRACT

An object recognition apparatus may determine a first point where a portion of an object closest to a vehicle is projected onto a ground, a second point where a portion of the object furthest from the vehicle in a longitudinal direction is projected onto the ground, and a third point where a portion of the object furthest from the vehicle in a lateral direction is projected onto the ground, determine, based on a top-view perspective of the object, top-view points respectively corresponding to the first point, the second point, and the third point, determine, based on a second plurality of line segments connecting the top-view points, at least one of a length, a width, or a heading, track a position of the object based on at least one of the length, the width, or the heading of the object, and control the vehicle.

### CROSS-REFERENCE TO RELATED APPLICATION

This application claims the benefit of priority to Korean Patent Application No. 10-2024-0045436, filed in the Korean Intellectual Property Office on Apr. 3, 2024, the entire contents of which are incorporated herein by reference.

### TECHNICAL FIELD

The present disclosure relates to an object recognition apparatus and an object recognition method, and more particularly, to a technique for improving the accuracy of information about an object based on images acquired by a camera.

### BACKGROUND

In autonomous vehicles and vehicles driven by driving assistance devices, detection of surrounding environments is essential for avoiding obstacles and identifying risks.

A vehicle may acquire information about the position of an object in the vehicle's vicinity through a light detection and ranging (LIDAR) device, a radar, a camera, or other sensors.

The information indicating the position of an object may be obtained primarily from a LIDAR or a radar. However, when it is difficult to obtain information from a LIDAR or a radar, or when the information obtained from the LIDAR or the radar needs to be supplemented, it may be necessary to obtain information indicative of the position of an object via a camera.

Because camera images may lack depth information, it may be difficult to identify the position of an object. Accordingly, new techniques are being developed to improve the accuracy of information indicating the position of an object in a camera image.

### SUMMARY

The present disclosure has been made to solve the above-mentioned problems occurring in at least some implementations while advantages achieved by those implementations are maintained intact.

An aspect of the present disclosure provides an object recognition apparatus and an object recognition method, which are capable of improving the accuracy of information indicating the position of an object obtained via a camera.

An aspect of the present disclosure provides an object recognition apparatus and an object recognition method, which are capable of intuitively presenting information indicating the position of an object obtained via a camera through a top-view screen.

An aspect of the present disclosure provides an object recognition apparatus and an object recognition method, which are capable of improving the accuracy of the speed of an identified object by improving the accuracy of the position of the object.

An aspect of the present disclosure provides an object recognition apparatus and an object recognition method, which are capable of improving the accuracy of the heading of an identified object by improving the accuracy of the position of the object.

An aspect of the present disclosure provides an object recognition apparatus and an object recognition method, which are capable of improving the accuracy of tracking an identified object by improving the accuracy of the position of the object.

An aspect of the present disclosure provides an object recognition apparatus and an object recognition method, which are capable of tracking the same point of an object.

An aspect of the present disclosure provides an object recognition apparatus and an object recognition method, which are capable of improving performance of post-processing of object recognition via a camera.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, an object recognition apparatus of a vehicle may include: a camera; and a processor. The processor may be configured to: obtain, via the camera, at least one image of an object external to the vehicle; and determine, based on the at least one image, a camera object box including a first plurality of line segments. The camera object box may be a two-dimensional rectangular box. The camera object box may surround an object image that represents the object. The processor may be configured to: determine, based on inputting information about the first plurality of line segments of the camera object box into a model that is trained through machine learning: a first point where a portion, of the object, closest to the vehicle is projected onto a ground from an outer contour of the object image, a second point where a portion, of the object, furthest from the vehicle in a longitudinal direction is projected onto the ground from the outer contour of the object image, and a third point where a portion, of the object, furthest from the vehicle in a lateral direction is projected onto the ground from the outer contour of the object image; determine, based on a top-view perspective of the object, top-view points respectively corresponding to the first point, the second point, and the third point; determine, based on a second plurality of line segments connecting the top-view points, at least one of a length of the object, a width of the object, or a heading of the object; track, based on at least one of the length, the width, or the heading of the object, a position of the object; and control, based on the tracked position of the object, the vehicle.

The information about the first plurality of line segments may include at least one of: a longitudinal position of a midpoint of a line segment. The line segment may be closest, among the first plurality of line segments, to the ground, a lateral position of the midpoint, a width of the camera object box, a height of the camera object box, an area of the camera object box, or a ratio of the width to the height. The top-view points may include: a first top-view point corresponding to the first point, a second top-view point corresponding to the second point, and a third top-view point corresponding to the third point.

The processor may be configured to determine at least one of the length, the width, or the heading, further based on at least one of: a longitudinal position of the first top-view point, a lateral position of the first top-view point, a longitudinal position of the second top-view point, a lateral position of the second top-view point, a longitudinal position of the third top-view point, or a lateral position of the third top-view point.

The processor may be configured to determine at least one of the length, the width, or the heading by: determining the width of the object by determining, based on longitudinal and lateral positions of the first top-view point and longitudinal and lateral positions of the second top-view point, a length of a first side of the object; and determining the length of the object by determining, based on the longitudinal and lateral positions of the first top-view point and longitudinal and lateral positions of the third top-view point, a length of a second side of the object.

The processor may be further configured to: display a top-view image representing a position, relative to the vehicle, of the object. The top-view image may be based on a longitudinal position and a lateral position of the first top-view point, a longitudinal position and a lateral position of the second top-view point, and a longitudinal position and a lateral position of the third top-view point.

The processor may be configured to track to the position of the object by: repeatedly performing, for each frame of the at least one image, processes of: the obtaining of the at least one image, the determining of the camera object box, the determining of the first point, the second point, and the third point, and the determining of at least one of the length, the width, or the heading; and tracking the position of the object based on at least one of the length, the width, or the heading in each frame of the at least one image.

The object recognition apparatus may further include a light detection and ranging (LIDAR) device. The processor may be further configured to: obtain, via the LIDAR device, a LIDAR object box that surrounds the object image. The LIDAR object box may be a three-dimensional hexahedron box. The LIDAR object box may include four top vertices and four bottom vertices. The four bottom vertices of the LIDAR object box may be closer, to the ground, than the four top vertices of the LIDAR object box. The four bottom vertices of the LIDAR object box may include: a first vertex that is closest, among the four bottom vertices, to the vehicle, and a second vertex and a third vertex that are on both sides of the first vertex. The second vertex may be closer, between the second vertex and the third vertex, to the vehicle; and train the model based on: inputting, as training data for the first point, a point obtained by projecting, into the at least one image of the object, the first vertex. The processor may be further configured to: input, as training data for the second point, a point obtained by projecting, into the at least one image of the object, the second vertex; and inputting, as training data for the third point, a point obtained by projecting, into the at least one image of the object, the third vertex.

The processor may be configured to determine the camera object box by determining, from each of a plurality of frames of the at least one image, the camera object box. The first point, the second point, and the third point may be determined from each of the camera object boxes in the plurality of frames. The processor may be further configured to: determine, based on a difference between a first position in a first frame of the plurality of frames and a second position in a second frame of the plurality of frames, a speed of the object in the second frame. The first position may be at least one of the first point, the second point, or the third point in the first frame. The second position may be at least one of the first point, the second point, or the third point in the second frame. The second frame may occur later than the first frame in the at least one image.

The processor may be configured to determine the camera object box by determining, from each of a plurality of frames of the at least one image, the camera object box. The first point, the second point, and the third point may be determined from each of the camera object boxes in the plurality of frames. The processor may be further configured to: determine, based on a difference between a first position in a first frame of the plurality of frames and a second position in a second frame of the plurality of frames, a traveling direction of the object. The first position may be at least one of the first point, the second point, or the third point in the first frame. The second position may be at least one of the first point, the second point, or the third point in the second frame. The second frame may occur later than the first frame in the at least one image.

The processor may be configured to determine the camera object box by determining, from each of a plurality of frames of the at least one image, the camera object box. The first point, the second point, and the third point may be determined from each of the camera object boxes in the plurality of frames. The processor may be further configured to: determine a speed of the object by comparing the first point in a first frame of the plurality of frames with the first point in a second frame of the plurality of frames. The second frame may occur later than the first frame. A first portion, of the object, corresponding to the first point in the first frame may coincide with a second portion, of the object, corresponding to the first point in the second frame.

The processor may be further configured to: model, based on performing regression, a relationship between: input data including information about the camera object box, and output data including the first point, the second point, and the third point.

According to one or more example embodiments of the present disclosure, an object recognition method, performed by an apparatus of a vehicle, may include: obtaining, via a camera, at least one image of an object external to the vehicle; and determining, based on the at least one image, a camera object box including a first plurality of line segments. The camera object box may be a two-dimensional rectangular box. The camera object box may surround an object image that represents the object. The object recognition method may further include: determining, based on inputting information about the first plurality of line segments of the camera object box into a model that is trained through machine learning: a first point where a portion, of the object, closest to the vehicle is projected onto a ground from an outer contour of the object image, a second point where a portion, of the object, furthest from the vehicle in a longitudinal direction is projected onto the ground from the outer contour of the object image, and a third point where a portion, of the object, furthest from the vehicle in a lateral direction is projected onto the ground from the outer contour of the object image; determining, based on a top-view perspective of the object, top-view points respectively corresponding to the first point, the second point, and the third point; determining, based on a second plurality of line segments connecting the top-view points, at least one of a length of the object, a width of the object, or a heading of the object; tracking, based on at least one of the length, the width, or the heading, a position; and control, based on the tracked position of the object, the vehicle.

The information about the first plurality of line segments may include at least one of: a longitudinal position of a midpoint of a line segment. The line segment may be closest, among the first plurality of line segments, to the ground, a lateral position of the midpoint, a width of the camera object box, a height of the camera object box, an area of the camera object box, or a ratio of the width to the height. The top-view points may include: a first top-view point corresponding to the first point, a second top-view point corresponding to the second point, and a third top-view point corresponding to the third point.

Determining at least one of the length, the width, or the heading may include determining at least one of the length, the width, or the heading, further based on at least one of: a longitudinal position of the first top-view point, a lateral position of the first top-view point, a longitudinal position of the second top-view point, a lateral position of the second top-view point, a longitudinal position of the third top-view point, or a lateral position of the third top-view point.

Determining at least one of the length, the width, or the heading may include: determining the width of the object by determining, based on longitudinal and lateral positions of the first top-view point and longitudinal and lateral positions of the second top-view point, a length of a first side of the object; and determining the length of the object by determining, based on the longitudinal and lateral positions of the first top-view point and longitudinal and lateral positions of the third top-view point, a length of a second side of the object.

The object recognition method may further include: displaying a top-view image representing a position, relative to the vehicle, of the object. The top-view image may be based on a longitudinal position and a lateral position of the first top-view point, a longitudinal position and a lateral position of the second top-view point, and a longitudinal position and a lateral position of the third top-view point.

Tracking the position of the object may include: repeatedly performing, for each frame of the at least one image, processes of: the obtaining of the at least one image, the determining of the camera object box, the determining of the first point, the second point, and the third point, and the determining of at least one of the length, the width, or the heading; and tracking the position of the object based on at least one of the length, the width, or the heading in each frame of the at least one image.

The object recognition method may further include: obtaining, via a light detection and ranging (LIDAR) device, a LIDAR object box that surrounds the object image. The LIDAR object box is a three-dimensional hexahedron box. The LIDAR object box may include four top vertices and four bottom vertices. The four bottom vertices of the LIDAR object box may be closer, to the ground, than the four top vertices of the LIDAR object box. The four bottom vertices of the LIDAR object box may include: a first vertex that is closest, among the four bottom vertices, to the vehicle, and a second vertex and a third vertex that are on both sides of the first vertex. The second vertex may be closer, between the second vertex and the third vertex, to the vehicle. The method may further include training the model based on: inputting, as training data for the first point, a point obtained by projecting, into the at least one image of the object, the first vertex; inputting, as training data for the second point, a point obtained by projecting, into the at least one image of the object, the second vertex; and inputting, as training data for the third point, a point obtained by projecting, into the at least one image of the object, the third vertex.

Determining the camera object box may include determining, from each of a plurality of frames of the at least one image, the camera object box. The first point, the second point, and the third point may be determined from each of the camera object boxes in the plurality of frames. The method may further include: determining, based on a difference between a first position in a first frame of the plurality of frames and a second position in a second frame of the plurality of frames, a speed of the object in the second frame. The first position may be at least one of the first point, the second point, or the third point in the first frame. The second position may be at least one of the first point, the second point, or the third point in the second frame. The second frame may occur later than the first frame in the at least one image.

Determining the camera object box may include determining, from each of a plurality of frames of the at least one image, the camera object box. The first point, the second point, and the third point may be determined from each of the camera object boxes in the plurality of frames. The method may further include: determining, based on a difference between a first position in a first frame of the plurality of frames and a second position in a second frame of the plurality of frames, a traveling direction of the object. The first position may be at least one of the first point, the second point, or the third point in the first frame. The second position may be at least one of the first point, the second point, or the third point in the second frame. The second frame may occur later than the first frame in the at least one image.

Determining the camera object box may include determining, from each of a plurality of frames of the at least one image, the camera object box. The first point, the second point, and the third point may be determined from each of the camera object boxes in the plurality of frames. The method may further include: determining a speed of the object by comparing the first point in a first frame of the plurality of frames with the first point in a second frame of the plurality of frames. The second frame may occur later than the first frame. A first portion, of the object, corresponding to the first point in the first frame may coincide with a second portion, of the object, corresponding to the first point in the second frame.

The object recognition method may further include: modeling, based on performing regression, a relationship between: input data including information about the camera object box, and output data including the first point, the second point, and the third point.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing a configuration of an object recognition apparatus according to an embodiment of the present disclosure;

FIG. 2 illustrates flow of operations of an object recognition apparatus for tracking an object based on information acquired via a camera, in an object recognition apparatus or an object recognition method according to an embodiment of the present disclosure;

FIG. 3 shows an example of input data and output data for a model trained through machine learning in an object recognition apparatus or an object recognition method according to an embodiment of the present disclosure;

FIG. 4 shows a flowchart of operations of an object recognition apparatus for tracking an object in an object recognition apparatus or an object recognition method according to an embodiment of the present disclosure;

FIG. 5 shows an example of the position of an object identified in an object recognition apparatus or an object recognition method according to an embodiment of the present disclosure and an example of the position of an object identified in a conventional object recognition apparatus or a conventional object recognition method;

FIG. 6 shows an example of a table showing errors in positions identified in an object recognition apparatus or an object recognition method according to an embodiment of the present disclosure;

FIG. 7 shows an example of object identification performed in an object recognition apparatus or an object recognition method according to an embodiment of the present disclosure;

FIG. 8 shows another example of object identification performed in an object recognition apparatus or an object recognition method according to an embodiment of the present disclosure; and

FIG. 9 illustrates a computing system related to an object recognition apparatus or an object classification method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

In addition, in the present disclosure, the expressions “greater than” or “less than” may be used to indicate whether a specific condition is satisfied or fulfilled, but are used only to indicate examples, and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. In addition, ‘A’ to ‘B’ means at least one of elements from ‘A’ (including ‘A’) to ‘B’ (including ‘B’).

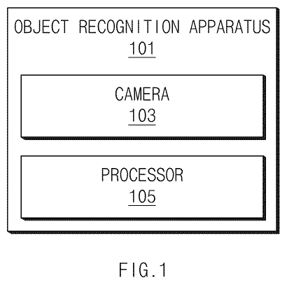

Hereinafter, embodiments of the present disclosure will be described in detail with reference to FIGS. 1 to 9.

FIG. 1 is a block diagram showing a configuration of an object recognition apparatus according to an embodiment of the present disclosure.

Referring to FIG. 1, an object recognition apparatus 101 may include a camera 103 and a processor 105.

The camera 103 and the processor 105 may be electronically and/or operably coupled with each other by an electronic component such as a communication bus.

According to an embodiment, hereinafter, combining pieces of hardware operatively may mean a direct connection or an indirect connection between the pieces of hardware being established in a wired or wireless manner such that first hardware of the pieces of hardware is controlled by second hardware of the pieces of hardware. The type and/or number of hardware included in the object recognition apparatus 101 is not limited to that shown in FIG. 1. For example, the object recognition apparatus 101 may include only some of hardware components shown in FIG. 1.

According to an embodiment, the processor 105 of the object recognition apparatus 101 may identify an object located outside of a host vehicle (e.g., a vehicle hosting the object recognition apparatus 101) based on the camera 103. For example, the processor 105 of the object recognition apparatus 101 may acquire an image including an object via the camera 103.

The object recognition apparatus 101 may be (or may be coupled to) a vehicle control device that may use information of various sensors (e.g., camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, etc.), for example, for autonomous driving control of the vehicle.

The object recognition apparatus 101 and/or the vehicle control device may control the vehicle using at least one selected precise path. For example, the vehicle control device may control the vehicle using an autonomous driving module and/or advanced driver assistance systems (ADAS). An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.)

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

According to an embodiment, the processor 105 of the object recognition apparatus 101 may identify a camera object box that includes the object on the image acquired via the camera 103 and represents a two-dimensional, virtual, and rectangular box. In other words, the camera object box may represent an object box included in the image.

The camera object box may include a virtual box that is assigned information related to the object outside of the host vehicle, based on the image acquired via the camera.

According to an embodiment, the processor 105 of the object recognition apparatus 101 may identify a first point, a second point, and a third point from the image based on a model trained through machine learning.

According to an embodiment, the first point may include a point where a portion of an object closest to the host vehicle from the outer contour of an object image representing an object is projected onto the ground, the point being included in the camera object box. The second point may include a point where a portion of an object furthest from the host vehicle in the longitudinal direction on the outer contour of the object image is projected onto the ground, the point being included in the camera object box. The third point may include a point where a portion of an object furthest from the host vehicle in the lateral direction is projected onto the ground on the outer contour of the object image.

According to an embodiment, the processor 105 of the object recognition apparatus 101 may input information about the points of an object acquired via a LIDAR as training data to train a model.

According to an embodiment, the processor 105 of the object recognition apparatus 101 may train the model based on inputting, as training data representing (e.g., for) the first point, a point obtained by converting (e.g., projecting) a first vertex that is closest (e.g., among four bottom vertices of a LIDAR object box) to the vehicle into a point on the image. The LIDAR object box may include four top vertices and four bottom vertices (e.g., the four top vertices and the four bottom vertices may be the eight vertices of the hexahedron box). Each of the four bottom vertices of the LIDAR object box may be closer to the ground than the four bottom vertices of the LIDAR object box. The four bottom vertices may include a first vertex that is closest to the vehicle among the four bottom vertices. Two of the bottom vertices that are on either side of (e.g., on both sides of) the first vertex may be referred to as a second vertex and a third vertex. Of the second vertex and the third vertex, the second vertex may be closer (e.g., than the third vertex) to the vehicle. Of the second vertex and the third vertex, the third vertex may be father away (e.g., than the second vertex) from the vehicle. The LIDAR object box may be obtained via a LiDAR. The LIDAR object box may include an object (e.g., surround an object image of the object) and may be (e.g., represented as) a three-dimensional virtual hexahedron box. The vertices on both sides of the first vertex may include vertices that are part of the four vertices.

The LIDAR object box may include a virtual box that is assigned information related to the object outside of the host vehicle, based on the image acquired via the LIDAR. For example, the object box may be referred to as a contour box.

According to an embodiment, the processor 105 of the object recognition apparatus 101 may train the model based on inputting, as training data representing (e.g., for) the second point, a point obtained by converting (e.g., projecting) the second vertex closer (e.g., closest) to the host vehicle among the vertices on both sides of the first vertex into a point on the image.

According to an embodiment, the processor 105 of the object recognition apparatus 101 may train the model based on inputting, as training data representing (e.g., for) the third point, a point obtained by converting (e.g., projecting) the third vertex further away from the host vehicle and different from the second vertex among the vertices on both sides of the first vertex into a point on the image.

According to an embodiment, the processor 105 of the object recognition apparatus 101 may output the first point, the second point, and the third point as output data by inputting, as input data, at least one of a longitudinal position and a lateral position of a midpoint with respect to the line segment closest to the ground among the line segments constituting the camera object box, a width of the camera object box, a height of the camera object box, an area of the camera object box, or a ratio of the width to the height of the camera object box, or any combination thereof to a model trained through machine learning.

According to an embodiment, the processor 105 of the object recognition apparatus 101 may convert coordinates of a specific point on the image (e.g., the first point, the second point, or the third point) to coordinates on the top-view (e.g., a top-view perspective of the object) corresponding to the specific point. For example, the processor 105 of the object recognition apparatus 101 may convert a position of a specific point on the image (e.g., a longitudinal position or a lateral position) to a position on the top-view corresponding to the specific point.

According to one embodiment, the processor 105 of the object recognition apparatus 101 may identify at least one of the length, width, or heading of an object (and/or an object box corresponding to the object), or any combination thereof, based on at least one of the longitudinal and lateral positions of a first top-view point, which is a point on a top-view corresponding to the first point, the longitudinal and lateral positions of a second top-view point, which is a point on the top-view corresponding to the second point, or the longitudinal and lateral positions of a third top-view point, which is a point on the top-view corresponding to the third point, or any combination thereof.

For example, the processor 105 of the object recognition apparatus 101 may identify a speed of the object on the second frame based on a difference between a position of one point of the first, second, and third points on the first frame and a position of a point corresponding to the one point on the second frame, which is subsequent to the first frame.

As an example, the processor 105 of the object recognition apparatus 101 may identify that a value, obtained by dividing, by a difference between the time when the second frame is acquired and the time when the first frame is acquired, the absolute value of a difference between the position of the one point (e.g., first point, second point, or third point) on the first frame and the position of a point corresponding to the one point on the second frame, is included in the speed of the object on the second frame.

For example, the processor 105 of the object recognition apparatus 101 may identify a heading of the object on the fourth frame based on a difference between a position of one point of the first, second, and third points on the third frame and a position of a point corresponding to the one point on the fourth frame, which is subsequent to the third frame.

As an example, the processor 105 of the object recognition apparatus 101 may identify the heading of the object on the fourth frame based on a direction indicated by a value obtained by subtracting the position of a point corresponding to the one point on the third frame from the position of the one point (e.g., first point, second point, or third point) on the fourth frame. The position of the one point on the fourth frame and the position of a point corresponding to the one point on the third frame may be vector values.

For example, the processor 105 of the object recognition apparatus 101 may identify, as the width of an object, the length of one side of the object, based on the longitudinal and lateral positions of the first top-view point and the longitudinal and lateral positions of the second top-view point.

As an example, the processor 105 of the object recognition apparatus 101 may identify the width of the object based on a distance between the first top-view point and the second top-view point.

For example, the processor 105 of the object recognition apparatus 101 may identify, as the length of an object, the length of another side different from the one side of the object, based on the longitudinal and lateral positions of the first top-view point and the longitudinal and lateral positions of the third top-view point.

As an example, the processor 105 of the object recognition apparatus 101 may identify the length of the object based on a distance between the first top-view point and the third top-view point.

For example, the processor 105 of the object recognition apparatus 101 may identify the heading of an object, based on an angle between the line segment formed by the first top-view point and the second top-view point, and the line segment formed by the first top-view point and the third top-view point.

According to an embodiment, the processor 105 of the object recognition apparatus 101 may repeatedly perform processes of re-acquiring an image of an object via the camera 103, identifying a camera object box based on the re-acquired image, identifying a first point, a second point, and a third point, and identifying at least one of the length, width, or heading of the object or any combination thereof, on a per-frame basis.

According to one embodiment, the processor 105 of the object recognition apparatus 101 may track the object based on at least one of the length, width, and heading of the object, a traveling direction of the object, or any combination thereof.

According to an embodiment, the processor 105 of the object recognition apparatus 101 may provide a driver with a top-view screen showing a relative position of the object with respect to the host vehicle based on a longitudinal position and a lateral position of a first top-view point, a longitudinal position and a lateral position of a second top-view point, and a longitudinal position and a lateral position of a third top-view point.

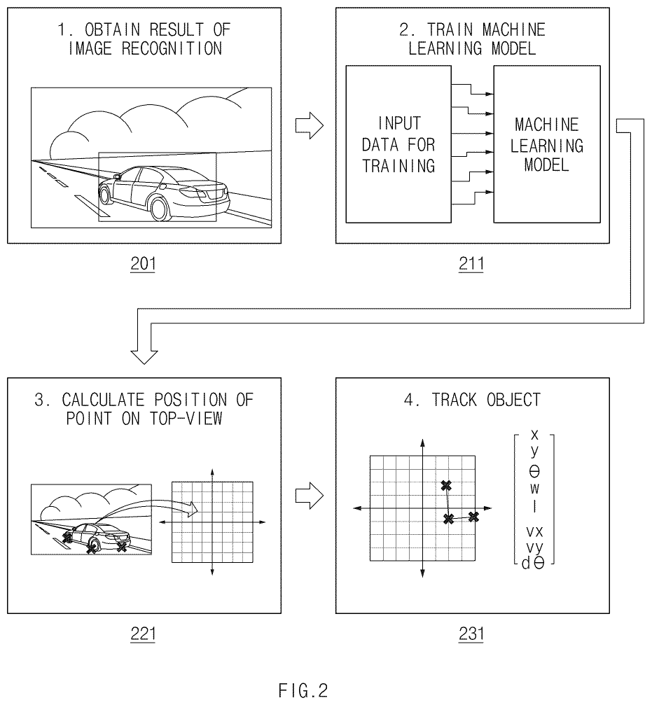

FIG. 2 illustrates a flow of operations of an object recognition apparatus for tracking an object based on information acquired via a camera, in an object recognition apparatus or an object recognition method according to an embodiment of the present disclosure.

Hereinafter, it is assumed that the processor 105 of the object recognition apparatus 101 of FIG. 1 performs the process of FIG. 2. Also, in the description of FIG. 2, the operations described as being performed by the processor of the object recognition apparatus may be understood as being controlled by the processor 105 of the object recognition apparatus 101.

Referring to FIG. 2, in a first operation 201, the processor of an object recognition apparatus according to an embodiment may obtain a result of image recognition. The processor of the object recognition apparatus may identify a camera object box that includes an object and represents a two-dimensional virtual square box through a deep learning-based artificial neural network from an image identified by a camera. In addition, the processor of the object recognition apparatus may identify, through the artificial neural network, at least one of longitudinal and lateral positions of the midpoint of the line segment closest to the ground among the line segments constituting the camera object box, the width of the camera object box, the height of the camera object box, the area of the camera object box, or the ratio of the width of the camera object box to the height of the camera object box, or any combination thereof.

In a second operation 211, the processor of the object recognition apparatus according to an embodiment may train a machine learning model.

According to an embodiment, the processor of the object recognition apparatus may input information about the points of an object obtained via a LIDAR as training data to train the model.

For example, training data representing a first point may include a point obtained by converting the first vertex closest to a host vehicle among four vertices close to the ground of a LIDAR object box to a point on an image.

For example, training data representing a second point may include a point obtained by converting a second vertex, which is closer to the host vehicle, among the vertices on both sides of the first vertex, to a point on the image.

For example, training data representing the third point may include a point where, among the vertices on both sides of the first vertex, a third vertex, which is farther from the host vehicle and different from the second vertex, is converted to a point on the image. The vertices on both sides of the first point may include vertices that are some of the four vertices.

In a third operation 221, the processor of the object recognition apparatus according to an embodiment may calculate the position of a point on the top-view. According to an embodiment, the processor of the object recognition apparatus may convert coordinates of a specific point on the image (e.g., the first point, the second point, or the third point) to coordinates on the top-view corresponding to the specific point. For example, the processor of the object recognition apparatus may convert a position of a specific point on the image (e.g., a longitudinal position or a lateral position) to a position on the top-view corresponding to the specific point.

In a fourth operation 231, the processor of the object recognition apparatus according to an embodiment may track an object. According to an embodiment, the processor of the object recognition apparatus may identify at least one of a longitudinal position (e.g., x), lateral position (e.g., y), length (e.g., l), and width (e.g., W), heading (e.g., θ) of an object, a longitudinal speed of the object (e.g., vx), a lateral speed of the object (e.g., vy), an amount of change in heading (e.g., dθ), or a traveling direction of the object, or any combination thereof.

For example, the processor of the object recognition apparatus may identify, as the width of an object, the length of one side of the object, based on the longitudinal and lateral positions of the first top-view point and the longitudinal and lateral positions of the second top-view point.

For example, the processor 105 of the object recognition apparatus 101 may identify, as the length of an object, the length of another side different from the one side of the object, based on the longitudinal and lateral positions of the first top-view point and the longitudinal and lateral positions of the third top-view point.

For example, the processor 105 of the object recognition apparatus 101 may identify the heading of an object, based on an angle between the line segment formed by the first top-view point and the second top-view point, and the line segment formed by the first top-view point and the third top-view point.

The processor of the object recognition apparatus according to an embodiment may identify an object image representing the same object in a plurality of frames and track the object, based on at least one of the length, width, or heading of the object, or any combination thereof.

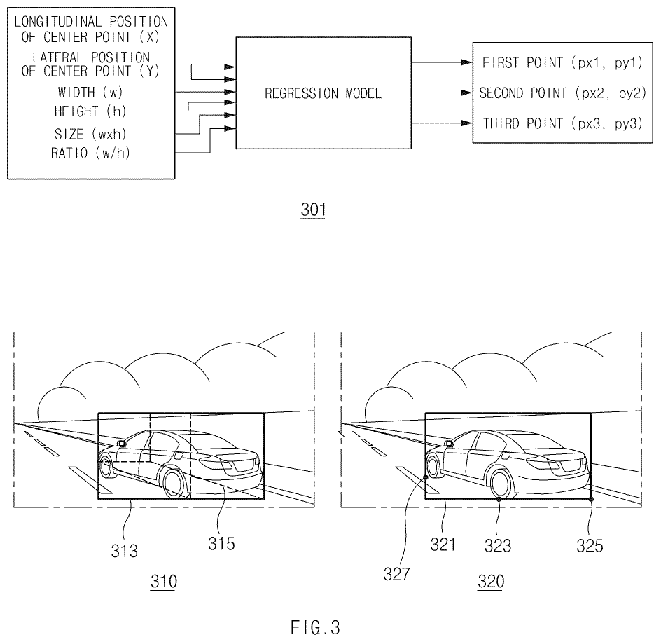

FIG. 3 shows an example of input data and output data for a model trained through machine learning in an object recognition apparatus or an object recognition method according to an embodiment of the present disclosure.

Referring to FIG. 3, a model 301 may include a machine learning model. Based on a first image 310, the processor of the object recognition apparatus may obtain a first camera object box 313 and a LIDAR object box 315 for training the model 301. Based on a second camera object box 321 included in a second image 320, the processor of the object recognition apparatus may obtain a first point 323, a second point 325, and a third point 327 from the model 301.

According to an embodiment, the model 301 may include a regression model. The regression model may predict output data for given input data by learning the relationship between input variables and output variables.

According to another embodiment, the model 301 may include a decision tree model or a random forest tree model.

According to an embodiment, the processor of the object recognition apparatus may model a relationship between information about the camera object box included in the input data and the first point, the second point, and the third point included in the output data, through machine learning, based on performing regression.

According to an embodiment, the processor of the object recognition apparatus may output the first point 323, the second point 325, and the third point 327 as output data by inputting, as input data, at least one of a longitudinal position and a lateral position of a midpoint with respect to the line segment closest to the ground among the line segments constituting the second camera object box 321, a width of the second camera object box 321, a height of the second camera object box 321, an area of the second camera object box 321, or a ratio of the width to the height of the second camera object box 321, or any combination thereof to the model 301 trained through machine learning.

According to an embodiment, the processor of the object recognition apparatus may convert coordinates of one point among the first point 323, the second point 325, and the third point 327 on the second image 320 to coordinates on a top-view corresponding to the one point. The processor of the object recognition apparatus may identify a position of the object on the top-view based on the coordinates of a first top-view point (e.g., px1, py1) corresponding to the first point 323, the coordinates of a second top-view point (e.g., px2, py2) corresponding to the second point 325, and the coordinates of the third top-view point (e.g., px3, py3) corresponding to the third point 327.

According to an embodiment, to obtain the output data, the processor of the object recognition apparatus may train a model, based on information about the first camera object box 313 and information about points where some of the vertices of the LIDAR object box 315 have been converted to points on the image.

For example, the information about the first camera object box 313 may include at least one of the longitudinal and lateral positions of the midpoint of the line segment closest to the ground among the line segments constituting the first camera object box 313, the width of the first camera object box 313, the height of the first camera object box 313, the area of the first camera object box 313, or the ratio of the width to the height, or any combination thereof.

For example, some of the vertices of the LIDAR object box 315 may include a vertex closest to a host vehicle among four vertices close to the ground of the LIDAR object box 315, and the vertices on both sides of the first point.

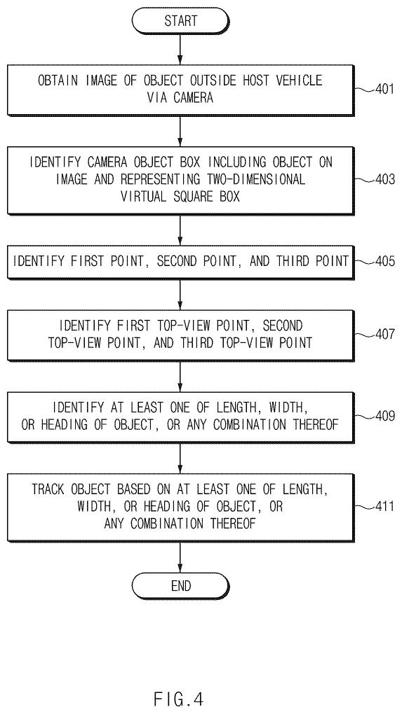

FIG. 4 shows a flowchart of operations of an object recognition apparatus for tracking an object in an object recognition apparatus or an object recognition method according to an embodiment of the present disclosure.

Hereinafter, it is assumed that the processor 105 of the object recognition apparatus 101 of FIG. 1 performs the process of FIG. 4. Also, in the description of FIG. 4, the operations described as being performed by the processor of the object recognition apparatus may be understood as being controlled by the processor 105 of the object recognition apparatus 101.

Referring to FIG. 4, in a first operation 401, the processor of the object recognition apparatus according to an embodiment may obtain an image of an object outside a host vehicle via a camera.

In a second operation 403, the processor of the object recognition apparatus according to an embodiment may identify a camera object box that includes an object on the image and represents a two-dimensional virtual square box.

In a third operation 405, the processor of the object recognition apparatus according to an embodiment may identify a first point, a second point, and a third point.

According to an embodiment, the first point may include a point where a portion of an object closest to the host vehicle is projected onto the ground, on the outer contour of the object image included in the camera object box and representing the object. The second point may include a point where a portion of the object furthest from the host vehicle in the longitudinal direction is projected onto the ground on the outer contour of the object image. The third point may include a point where a portion of the object furthest from the host vehicle in the lateral direction is projected onto the ground on the outer contour of the object image.

According to an embodiment, the processor of the object recognition apparatus may identify the first point, the second point, and the third point based on inputting information about the line segments constituting the camera object box into a model trained through machine learning.

According to an embodiment, information about the line segments constituting the camera object box may include at least one of the longitudinal and lateral positions of the midpoint of a line segment closest to the ground, the width of the camera object box, the height of the camera object box, the area of the camera object box, or the ratio of the width to the height, or any combination thereof.

In a fourth operation 407, the processor of the object recognition apparatus according to an embodiment may identify a first top-view point, a second top-view point, and a third top-view point.

According to an embodiment, the first top-view point may include a point on a top-view corresponding to the first point. The second top-view point may include a point on the top-view corresponding to the second point according to the second point. The third top-view point may include a point on the top-view corresponding to the third point according to the third point.

In a fifth operation 409, the processor of the object recognition apparatus according to an embodiment may identify at least one of the length, width, or heading of an object, or any combination thereof.

The processor of the object recognition apparatus according to an embodiment may identify at least one of the length, width, or heading of the object, or any combination thereof, based on a line segment connecting the first top-view point and the second top-view point, and a line segment connecting the first top-view point and the third top-view point.

According to an embodiment, the processor of the object recognition apparatus may identify one of the length, width, or heading of the object, or any combination thereof, based on at least one of the longitudinal and lateral positions of a point on the top-view corresponding to the first point, the longitudinal and lateral positions of a point on the top-view corresponding to the second point, or the longitudinal and lateral positions of a point on the top-view corresponding to the third point, or any combination thereof.

In a sixth operation 411, the processor of the object recognition apparatus according to an embodiment may track the object (e.g., track the position(s) of the object) based on at least one of the length, width, or heading of an object, or any combination thereof. The tracked position(s) of the object may be used to control the vehicle (e.g., perform steering, accelerating, braking, evasive maneuver, etc. based on the tracked position(s) of the object).

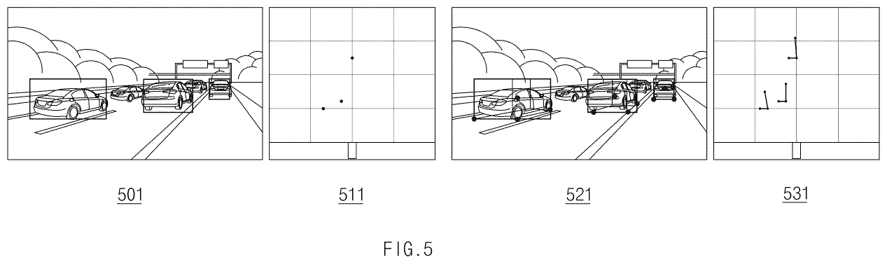

FIG. 5 shows an example of the position of an object identified in an object recognition apparatus or an object recognition method according to an embodiment of the present disclosure and an example of the position of an object identified in a conventional object recognition apparatus or a conventional object recognition method.

Referring to FIG. 5, a first image 501 may be obtained via a camera of a conventional object recognition apparatus and may include an object. A first screen 511 may be a screen showing the relative position of an object with respect to the host vehicle identified through a conventional object recognition apparatus on a top-view. A second image 521 may be acquired via the camera of the object recognition apparatus according to an embodiment and may include an object. A second screen 531 may be a screen showing the relative position of an object with respect to the host vehicle identified through the object recognition apparatus according to an embodiment on a top-view.

The processor of the conventional object recognition apparatus may display one dot for each individual object on the first screen 511.

The processor of the conventional object recognition apparatus may identify the relative position from the host vehicle to the object based on the midpoint of the line segment closest to the ground among the line segments constituting the camera object box including (e.g., that surrounds) the object. The processor of the conventional object recognition apparatus may output the first screen 511 based on the relative position from the host vehicle to the object. The processor of the conventional object recognition apparatus may track an object (e.g., track the position(s) of the object) in a plurality of frames based on the relative position from the host vehicle to the object.

The object recognition apparatus according to one embodiment may display three points for each individual object on the second screen 531.

The processor of the object recognition apparatus according to an embodiment may identify the relative position from the host vehicle to the object based on the first point, the second point, and the third point included in the camera object box including (e.g., that surrounds) the object. The processor of the object recognition apparatus according to an embodiment may output the second screen 531 based on the relative position from the host vehicle to the object.

The conventional object recognition apparatus may not be able to identify a portion of the object that is closest to the host vehicle, a portion of the object that is furthest from the host vehicle in the longitudinal direction on the image, or a portion of the object that is furthest from the host vehicle in the lateral direction on the image.

The accuracy of the distance or speed of an object identified by the object recognition apparatus according to an embodiment may be higher than the accuracy of the distance or speed of the object identified by the conventional object recognition apparatus. The reason for this is that, when the position of the object with respect to the host vehicle changes, the angle of the object with respect to the hot vehicle may change and therefore, the portion of the object corresponding to the center point of the line segment close to the ground of the camera object box may also change. In other words, if the conventional object recognition apparatus measures a speed or distance based on the center point of a specific frame and the center point of a frame subsequent to the specific frame, this is because the measurements are not made on the same portion of the object.

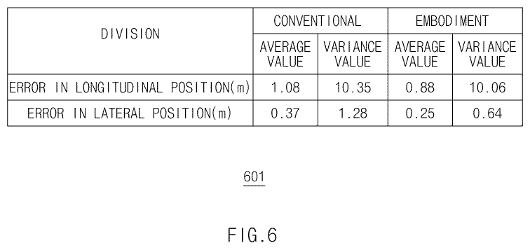

FIG. 6 shows an example of a table showing errors in positions identified in an object recognition apparatus or an object recognition method according to an embodiment of the present disclosure.

Referring to FIG. 6, table 601 shows errors in longitudinal position and errors in lateral position for an object identified through a conventional object recognition apparatus and errors in longitudinal position and errors in lateral position for an object identified through an object recognition apparatus according to an embodiment. The longitudinal position of the object may include a longitudinal position corresponding to the rear bumper of a host vehicle. The lateral position of the object may include a lateral position corresponding to the rear bumper of the host vehicle.

The average value of the errors in longitudinal position of the object identified through the conventional object recognition apparatus may be about 1.08 m. The variance value of the errors in longitudinal position of the object identified through the conventional object recognition apparatus may be about 10.35 m².

The average value of the errors in lateral position of the object identified through the conventional object recognition apparatus may be about 0.37 m. The variance value of the errors in lateral position of the object identified through the conventional object recognition apparatus may be about 1.28 m².

The average value of the errors in the longitudinal position of an object identified through an object recognition apparatus according to an embodiment may be about 0.88 m. The variance value of the errors in longitudinal position of the object identified through the object recognition apparatus according to an embodiment may be about 10.06 m².

The average value of the errors in lateral position of the object identified through the object recognition apparatus according to an embodiment may be about 0.25 m. The variance value of the errors in longitudinal position of the object identified through the object recognition apparatus according to an embodiment may be about 0.64 m².

Referring to the table 601, the error in longitudinal position of the object identified through the object recognition apparatus according to an embodiment may be smaller than the error in longitudinal position of the object identified through the conventional object recognition apparatus.

Referring to the table 601, the error in lateral position of the object identified through the object recognition apparatus according to an embodiment may be smaller than the error in lateral position of the object identified through the conventional object recognition apparatus.

Therefore, the accuracy in position of the object identified through the object recognition apparatus according to an embodiment may be higher than the accuracy in position of the object identified through the conventional object recognition apparatus.

In other words, the processor of the object recognition apparatus according to an embodiment may acquire the accuracy of identifying the speed of the object, which is above a reference value, by comparing the first point on the fifth frame with the first point on the sixth frame, rather than by comparing the center point of the camera object box of the fifth frame with the center point of the camera object box of the sixth frame. A portion of the object corresponding to the first point of the fifth frame may coincide with a portion of the object corresponding to the first point of the sixth frame.

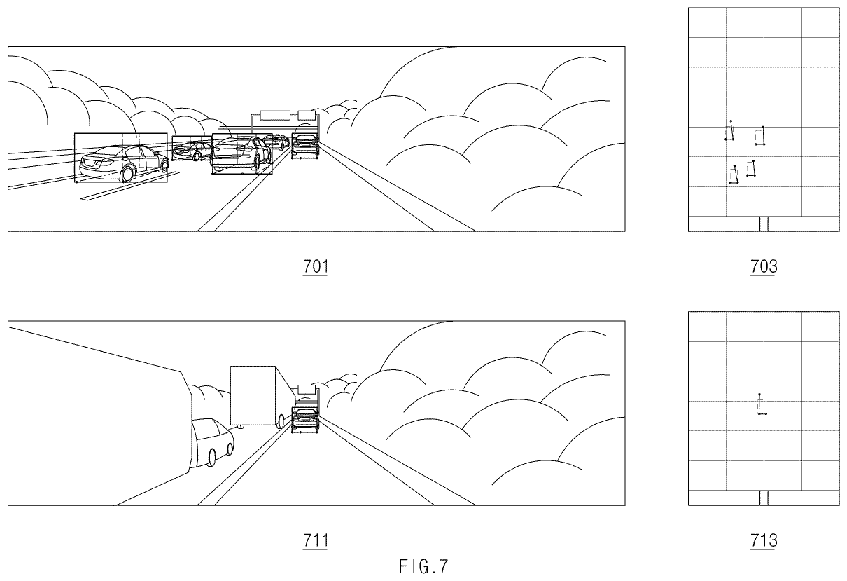

FIG. 7 shows an example of object identification performed in an object recognition apparatus or an object recognition method according to an embodiment of the present disclosure.

Referring to FIG. 7, in a first situation, a first image 701 may include a first point, a second point, and a third point identified via an object recognition apparatus according to an embodiment.

A first screen 703 may include a first top-view point, a second top-view point, and a third top-view point displayed in the first image 701.

In a second situation different from the first situation, a second image 711 may include a first point, a second point, and a third point identified via the object recognition apparatus according to an embodiment.

A second screen 713 may include a first top-view point corresponding to a first point displayed on the second image 711, a second top-view point corresponding to the second point, and a third top-view point corresponding to the third point.

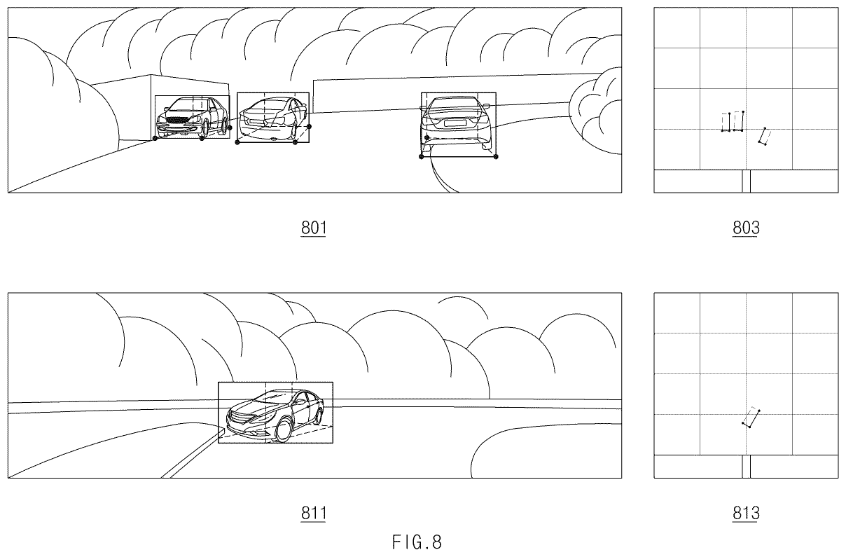

FIG. 8 shows another example of object identification performed in an object recognition apparatus or an object recognition method according to an embodiment of the present disclosure.

Referring to FIG. 8, in a third situation, a first image 801 may include a first point, a second point, and a third point identified through an object recognition apparatus according to an embodiment.

A first screen 803 may include a first top-view point corresponding to a first point displayed on the first image 801, a second top-view point corresponding to the second point, and a third top-view point corresponding to the third point.

In a fourth situation that is different from the third situation, a second image 811 may include a first point, a second point, and a third point identified via the object recognition apparatus according to an embodiment.

A second screen 813 may include a first top-view point corresponding to a first point displayed on the second image 811, a second top-view point corresponding to the second point, and a third top-view point corresponding to the third point.

According to an embodiment, if a 2D shape is identified in the image and the vehicle is output in an L shape on the top-view, the processor of the object recognition apparatus may estimate the closest point between the host vehicle and the object and the closest side between the host vehicle and the object.

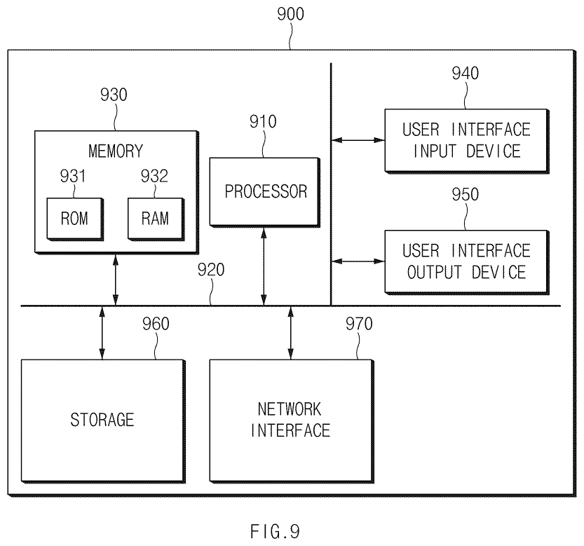

FIG. 9 illustrates a computing system related to an object recognition apparatus or an object classification method according to an embodiment of the present disclosure.

Referring to FIG. 9, a computing system 900 may include at least one processor 910, a memory 930, a user interface input device 940, a user interface output device 950, storage 960, and a network interface 970, which are connected with each other via a bus 920.

The processor 910 may be a central processing unit (CPU) or a semiconductor device that processes instructions stored in the memory 930 and/or the storage 960. The memory 930 and the storage 960 may include various types of volatile or non-volatile storage media. For example, the memory 930 may include a ROM (Read Only Memory) 931 and a RAM (Random Access Memory) 932.

Thus, the operations of the method or the algorithm described in connection with the embodiments disclosed herein may be embodied directly in hardware or a software module executed by the processor 910, or in a combination thereof. The software module may reside on a storage medium (that is, the memory 930 and/or the storage 960) such as a RAM, a flash memory, a ROM, an EPROM, an EEPROM, a register, a hard disk, a removable disk, and a CD-ROM.

The exemplary storage medium may be coupled to the processor 910, and the processor 910 may read information out of the storage medium and may record information in the storage medium. Alternatively, the storage medium may be integrated with the processor 910. The processor and the storage medium may reside in an application specific integrated circuit (ASIC). The ASIC may reside within a user terminal. In another case, the processor and the storage medium may reside in the user terminal as separate components.

According to an aspect of the present disclosure, an object recognition apparatus may include a camera and a processor.

According to an embodiment, the processor may obtain an image of an object outside a host vehicle via the camera, identify a camera object box including the object and representing a two-dimensional virtual square box, on the image, identify a first point where a portion of the object closest to the host vehicle is projected onto a ground, from an outer contour of an object image included in the camera object box and representing the object, a second point where a portion of the object furthest from the host vehicle in a longitudinal direction is projected onto the ground from the outer contour of the object image, and a third point where a portion of the object furthest from the host vehicle in a lateral direction is projected onto the ground from the outer contour of the object image, based on inputting information about line segments constituting the camera object box into a model trained through machine learning, identify top-view points which are points on a top-view respectively corresponding to the first point, the second point, and the third point according to the first point, the second point, and the third point, identify at least one of a length, a width, or a heading of the object, or any combination thereof, based on line segments connecting the top-view points, and track the object based on at least one of the length, the width, or the heading of the object, or any combination thereof.

According to an embodiment, the processor may identify the first point, the second point, and the third point, based on information about the line segments including at least one of longitudinal and lateral positions of a midpoint of a line segment closest to the ground among the line segments constituting the camera object box, a width of the camera object box, a height of the camera object box, an area of the camera object box, or a ratio of the width to the height, or any combination thereof. The point on the top-view included in the top-view points and corresponding to the first point may include a first top-view point, the point on the top-view included in the top-view points and corresponding to the second point may include a second top-view point, and the point on the top-view included in the top-view points and corresponding to the third point may include a third top-view point.

According to an embodiment, the processor may repeatedly perform processes of re-acquiring an image of the object via the camera, identifying the camera object box based on the re-acquired image, identifying the first point, the second point, and the third point, and identifying at least one of the length, the width, or the heading of the object or any combination thereof, on a per-frame basis, and track the object based on at least one of the length, the width, or the heading of the object, or any combination thereof,

According to an embodiment, the object recognition apparatus may further include a LIDAR. The processor may train the model based on inputting, as training data representing the first point, a point obtained by converting a first vertex closest to the host vehicle among four vertices close to the ground of a LIDAR object box into a point on the image, the LIDAR object box being obtained via the LIDAR and including the object and representing a three-dimensional virtual hexahedron box, inputting, as training data representing the second point, a point obtained by converting a second vertex closer to the host vehicle among vertices on both sides of the first vertex into a point on the image, and inputting, as training data representing the third point, a point obtained by converting a third vertex which is farther from the host vehicle and different from the second vertex among the vertices on the both sides of the first vertex, into a point on the image. The vertices on the both sides of the first vertex may include vertices which are some of the four vertices.

According to an embodiment, the processor may identify at least one of the length, the width, or the heading of the object, or any combination thereof, based on at least one of a longitudinal position and a lateral position of the first top-view point, a longitudinal position and a lateral position of the second top-view point, or a longitudinal position and a lateral position of the third top-view point, or any combination thereof, and track the object based on at least one of the length, the width, or the heading of the object, or any combination thereof.

According to an embodiment, the processor may identify a speed of the object on a second frame based on a difference between a position of one point of the first point, the second point and the third point on a first frame, and a position of a point corresponding to the one point on the second frame subsequent to the first frame.

According to an embodiment, the processor may identify, as the width of the object, a length of one side of the object, based on longitudinal and lateral positions of the first top-view point and longitudinal and lateral positions of the second top-view point, and identify, as the length of the object, a length of another side different from the one side of the object, based on the longitudinal and lateral positions of the first top-view point and longitudinal and lateral positions of the third top-view point.

According to an embodiment, the processor may identify a traveling direction of the object on a fourth frame based on a difference between a position of one point of the first point, the second point and the third point on a third frame, and a position of a point corresponding to the one point on the fourth frame subsequent to the third frame.

According to an embodiment, the processor may acquire accuracy of identifying a speed of the object, which is above a reference value, by comparing the first point on a fifth frame and a first point on the sixth frame, rather than by comparing a center point of the camera object box on the fifth frame and a center point of the camera object box on the sixth frame subsequent to the fifth frame. A portion of the object corresponding to the first point on the fifth frame may coincide with a portion of the object corresponding to the first point on the sixth frame.

According to an embodiment, the processor may model a relationship between information about the camera object box included in input data and the first point, second point, and third point included in output data, through machine learning, based on performing regression.

According to an embodiment, the processor may provide a driver with a screen of the top-view representing a relative position of the object with respect to the host vehicle, based on a longitudinal position and a lateral position of the first top-view point, a longitudinal position and a lateral position of the second top-view point, and a longitudinal position and a lateral position of the third top-view point.

According to an aspect of the present disclosure, an object recognition method may include obtaining an image of an object outside a host vehicle via a camera, identifying a camera object box including the object and representing a two-dimensional virtual square box, on the image, identifying a first point where a portion of the object closest to the host vehicle is projected onto a ground, from an outer contour of an object image included in the camera object box and representing the object, a second point where a portion of the object furthest from the host vehicle in a longitudinal direction is projected onto the ground from the outer contour of the object image, and a third point where a portion of the object furthest from the host vehicle in a lateral direction is projected onto the ground from the outer contour of the object image, based on inputting information about line segments constituting the camera object box into a model trained through machine learning, identifying top-view points which are points on a top-view respectively corresponding to the first point, the second point, and the third point according to the first point, the second point, and the third point, identifying at least one of a length, a width, or a heading of the object, or any combination thereof, based on line segments connecting the top-view points, and tracking the object based on at least one of the length, the width, or the heading of the object, or any combination thereof.

According to an embodiment, the identifying of the first point where a portion of the object closest to the host vehicle is projected onto a ground, from an outer contour of an object image included in the camera object box and representing the object, the second point where a portion of the object furthest from the host vehicle in a longitudinal direction is projected onto the ground from the outer contour of the object image, and the third point where a portion of the object furthest from the host vehicle in a lateral direction is projected onto the ground from the outer contour of the object image, based on inputting information about line segments constituting the camera object box into a model trained through machine learning may include identifying the first point, the second point, and the third point, based on information about the line segments including at least one of longitudinal and lateral positions of a midpoint of a line segment closest to the ground among the line segments constituting the camera object box, a width of the camera object box, a height of the camera object box, an area of the camera object box, or a ratio of the width to the height, or any combination thereof. The point on the top-view included in the top-view points and corresponding to the first point may include a first top-view point, the point on the top-view included in the top-view points and corresponding to the second point may include a second top-view point, and the point on the top-view included in the top-view points and corresponding to the third point may include a third top-view point.

According to an embodiment, the object recognition method may further include repeatedly performing processes of re-acquiring an image of the object via the camera, identifying the camera object box based on the re-acquired image, identifying the first point, the second point, and the third point, and identifying at least one of the length, the width, or the heading of the object or any combination thereof, on a per-frame basis, and tracking the object based on at least one of the length, the width, or the heading of the object, or any combination thereof.

According to an embodiment, the object recognition method may further include training the model based on inputting, as training data representing the first point, a point obtained by converting a first vertex closest to the host vehicle among four vertices close to the ground of a LIDAR object box into a point on the image, the LIDAR object box being obtained via a LIDAR and including the object and representing a three-dimensional virtual hexahedron box, inputting, as training data representing the second point, a point obtained by converting a second vertex closer to the host vehicle among vertices on both sides of the first vertex into a point on the image, and inputting, as training data representing the third point, a point obtained by converting a third vertex which is farther from the host vehicle and different from the second vertex among the vertices on the both sides of the first vertex, into a point on the image. The vertices on the both sides of the first vertex may include vertices which are some of the four vertices.

According to an embodiment, the identifying of at least one of the length, the width, or the heading of the object, or any combination thereof, based on a line segment connecting the first top-view point and the second top-view point, and a line segment connecting the first top-view point and the third top-view point may include identifying of at least one of the length, the width, or the heading of the object, or any combination thereof, based on at least one of a longitudinal position and a lateral position of the first top-view point, a longitudinal position and a lateral position of the second top-view point, or a longitudinal position and a lateral position of the third top-view point, or any combination thereof.

According to an embodiment, the object recognition method may further include identifying a speed of the object on a second frame based on a difference between a position of one point of the first point, the second point and the third point on a first frame, and a position of a point corresponding to the one point on the second frame subsequent to the first frame.

According to an embodiment, the identifying of at least one of the length, the width, or the heading of the object, or any combination thereof, based on at least one of a longitudinal position and a lateral position of a point on the top-view corresponding to the first point, a longitudinal position and a lateral position of a point on the top-view corresponding to the second point, or a longitudinal position and a lateral position of a point on the top-view corresponding to the third point, or any combination thereof may include identifying, as the width of the object, a length of one side of the object, based on the longitudinal and lateral positions of the point on the top-view corresponding to the first point and the longitudinal and lateral positions of the point on the top-view corresponding to the second point, and identifying, as the length of the object, a length of another side different from the one side of the object, based on the longitudinal and lateral positions of the point on the top-view corresponding to the first point and the longitudinal and lateral positions of the point on the top-view corresponding to the third point.

According to an embodiment, the object recognition method may further include identifying a traveling direction of the object on a fourth frame based on a difference between a position of one point of the first point, the second point and the third point on a third frame, and a position of a point corresponding to the one point on the fourth frame subsequent to the third frame.

According to an embodiment, the object recognition method may further include acquiring accuracy of identifying a speed of the object, which is above a reference value, by comparing the first point on a fifth frame and a first point on the sixth frame, rather than by comparing a center point of the camera object box on the fifth frame and a center point of the camera object box on the sixth frame. A portion of the object corresponding to the first point on the fifth frame may coincide with a portion of the object corresponding to the first point on the sixth frame.

According to an embodiment, the object recognition method may further include modeling a relationship between information about the camera object box included in input data and the first point, second point, and third point included in output data, through machine learning, based on performing regression.

According to an embodiment, the object recognition method may further include providing a driver with a screen of the top-view representing a relative position of the object with respect to the host vehicle, based on longitudinal and lateral positions of the point on the top-view corresponding to the first point, longitudinal and lateral positions of the point on the top-view corresponding to the second point, and longitudinal and lateral positions of the point on the top-view corresponding to the third point.

The above description is merely illustrative of the technical idea of the present disclosure, and various modifications and variations may be made without departing from the essential characteristics of the present disclosure by those skilled in the art to which the present disclosure pertains.

Accordingly, the embodiment disclosed in the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

The present technology may improve the accuracy of information indicating the position of an object obtained via a camera.

Further, the present technology may intuitively present information indicating the position of an object obtained via a camera through a top-view screen.

Further, the present technology may improve the accuracy of the speed of an identified object by improving the accuracy of the position of the object.

Further, the present technology may improve the accuracy of the heading of an identified object by improving the accuracy of the position of the object.

Further, the present technology may improve the accuracy of the traveling direction of an identified object by improving the accuracy of the position of the object.

Further, the present technology may improve the accuracy of tracking an identified object by improving the accuracy of the position of the object.

Further, the present technology may track the same point of an object.

Further, the present technology may improve performance of post-processing of object recognition via a camera.

In addition, various effects may be provided that are directly or indirectly understood through the disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An object recognition apparatus of a vehicle, the object recognition apparatus comprising:
a camera; and
a processor,
wherein the processor is configured to:
obtain, via the camera, at least one image of an object external to the vehicle;
determine, based on the at least one image, a camera object box comprising a first plurality of line segments, wherein the camera object box is a two-dimensional rectangular box, and wherein the camera object box surrounds an object image that represents the object;
determine, based on inputting information about the first plurality of line segments of the camera object box into a model that is trained through machine learning:
a first point where a portion, of the object, closest to the vehicle is projected onto a ground from an outer contour of the object image,
a second point where a portion, of the object, furthest from the vehicle in a longitudinal direction is projected onto the ground from the outer contour of the object image, and
a third point where a portion, of the object, furthest from the vehicle in a lateral direction is projected onto the ground from the outer contour of the object image;
determine, based on a top-view perspective of the object, top-view points respectively corresponding to the first point, the second point, and the third point;
determine, based on a second plurality of line segments connecting the top-view points, at least one of a length of the object, a width of the object, or a heading of the object;
track, based on at least one of the length, the width, or the heading of the object, a position of the object; and
control, based on the tracked position of the object, the vehicle.

2. The object recognition apparatus of claim 1, wherein the information about the first plurality of line segments comprise at least one of:
a longitudinal position of a midpoint of a line segment, wherein the line segment is closest, among the first plurality of line segments, to the ground,
a lateral position of the midpoint,
a width of the camera object box,
a height of the camera object box,
an area of the camera object box, or
a ratio of the width to the height,
wherein the top-view points comprise:
a first top-view point corresponding to the first point,
a second top-view point corresponding to the second point, and
a third top-view point corresponding to the third point.

3. The object recognition apparatus of claim 2, wherein the processor is configured to determine at least one of the length, the width, or the heading, further based on at least one of:
a longitudinal position of the first top-view point,
a lateral position of the first top-view point,
a longitudinal position of the second top-view point,
a lateral position of the second top-view point,
a longitudinal position of the third top-view point, or
a lateral position of the third top-view point.

4. The object recognition apparatus of claim 2, wherein the processor is configured to determine at least one of the length, the width, or the heading by:
determining the width of the object by determining, based on longitudinal and lateral positions of the first top-view point and longitudinal and lateral positions of the second top-view point, a length of a first side of the object; and
determining the length of the object by determining, based on the longitudinal and lateral positions of the first top-view point and longitudinal and lateral positions of the third top-view point, a length of a second side of the object.

5. The object recognition apparatus of claim 2, wherein the processor is further configured to:
display a top-view image representing a position, relative to the vehicle, of the object, wherein the top-view image is based on a longitudinal position and a lateral position of the first top-view point, a longitudinal position and a lateral position of the second top-view point, and a longitudinal position and a lateral position of the third top-view point.

6. The object recognition apparatus of claim 1, wherein the processor is configured to track to the position of the object by:
repeatedly performing, for each frame of the at least one image, processes of:
the obtaining of the at least one image,
the determining of the camera object box,
the determining of the first point, the second point, and the third point, and
the determining of at least one of the length, the width, or the heading; and
tracking the position of the object based on at least one of the length, the width, or the heading in each frame of the at least one image.

7. The object recognition apparatus of claim 1, further comprising a light detection and ranging (LIDAR) device,
wherein the processor is further configured to:
obtain, via the LIDAR device, a LIDAR object box that surrounds the object image, wherein the LIDAR object box is a three-dimensional hexahedron box, wherein the LIDAR object box comprises four top vertices and four bottom vertices, wherein the four bottom vertices of the LIDAR object box are closer, to the ground, than the four top vertices of the LIDAR object box, wherein the four bottom vertices of the LIDAR object box comprise:
a first vertex that is closest, among the four bottom vertices, to the vehicle, and
a second vertex and a third vertex that are on both sides of the first vertex, wherein the second vertex is closer, between the second vertex and the third vertex, to the vehicle; and
train the model based on:
inputting, as training data for the first point, a point obtained by projecting, into the at least one image of the object, the first vertex;
inputting, as training data for the second point, a point obtained by projecting, into the at least one image of the object, the second vertex; and
inputting, as training data for the third point, a point obtained by projecting, into the at least one image of the object, the third vertex.

8. The object recognition apparatus of claim 1, wherein the processor is configured to determine the camera object box by determining, from each of a plurality of frames of the at least one image, the camera object box, wherein the first point, the second point, and the third point are determined from each of the camera object boxes in the plurality of frames, and
wherein the processor is further configured to:
determine, based on a difference between a first position in a first frame of the plurality of frames and a second position in a second frame of the plurality of frames, a speed of the object in the second frame, wherein the first position is at least one of the first point, the second point, or the third point in the first frame, wherein the second position is at least one of the first point, the second point, or the third point in the second frame, and wherein the second frame occurs later than the first frame in the at least one image.

9. The object recognition apparatus of claim 1, wherein the processor is configured to determine the camera object box by determining, from each of a plurality of frames of the at least one image, the camera object box, wherein the first point, the second point, and the third point are determined from each of the camera object boxes in the plurality of frames, and
wherein the processor is further configured to:
determine, based on a difference between a first position in a first frame of the plurality of frames and a second position in a second frame of the plurality of frames, a traveling direction of the object, wherein the first position is at least one of the first point, the second point, or the third point in the first frame, wherein the second position is at least one of the first point, the second point, or the third point in the second frame, and wherein the second frame occurs later than the first frame in the at least one image.

10. The object recognition apparatus of claim 1, wherein the processor is configured to determine the camera object box by determining, from each of a plurality of frames of the at least one image, the camera object box, wherein the first point, the second point, and the third point are determined from each of the camera object boxes in the plurality of frames, and
wherein the processor is further configured to:
determine a speed of the object by comparing the first point in a first frame of the plurality of frames with the first point in a second frame of the plurality of frames, wherein the second frame occurs later than the first frame,
wherein a first portion, of the object, corresponding to the first point in the first frame coincides with a second portion, of the object, corresponding to the first point in the second frame.

11. The object recognition apparatus of claim 1, wherein the processor is further configured to:
model, based on performing regression, a relationship between:
input data comprising information about the camera object box, and
output data comprising the first point, the second point, and the third point.

12. An object recognition method performed by an apparatus of a vehicle, the object recognition method comprising:
obtaining, via a camera, at least one image of an object external to the vehicle;
determining, based on the at least one image, a camera object box comprising a first plurality of line segments, wherein the camera object box is a two-dimensional rectangular box, and wherein the camera object box surrounds an object image that represents the object;
determining, based on inputting information about the first plurality of line segments of the camera object box into a model that is trained through machine learning:
a first point where a portion, of the object, closest to the vehicle is projected onto a ground from an outer contour of the object image,
a second point where a portion, of the object, furthest from the vehicle in a longitudinal direction is projected onto the ground from the outer contour of the object image, and
a third point where a portion, of the object, furthest from the vehicle in a lateral direction is projected onto the ground from the outer contour of the object image;
determining, based on a top-view perspective of the object, top-view points respectively corresponding to the first point, the second point, and the third point;
determining, based on a second plurality of line segments connecting the top-view points, at least one of a length of the object, a width of the object, or a heading of the object;
tracking, based on at least one of the length, the width, or the heading, a position; and
control, based on the tracked position of the object, the vehicle.

13. The object recognition method of claim 12, wherein the information about the first plurality of line segments comprise at least one of:
a longitudinal position of a midpoint of a line segment, wherein the line segment is closest, among the first plurality of line segments, to the ground,
a lateral position of the midpoint,
a width of the camera object box,
a height of the camera object box,
an area of the camera object box, or
a ratio of the width to the height,
wherein the top-view points comprise:
a first top-view point corresponding to the first point,
a second top-view point corresponding to the second point, and
a third top-view point corresponding to the third point.

14. The object recognition method of claim 13, wherein the determining of at least one of the length, the width, or the heading comprises determining at least one of the length, the width, or the heading, further based on at least one of:
a longitudinal position of the first top-view point,
a lateral position of the first top-view point,
a longitudinal position of the second top-view point,
a lateral position of the second top-view point,
a longitudinal position of the third top-view point, or
a lateral position of the third top-view point.

15. The object recognition method of claim 13, wherein the determining of at least one of the length, the width, or the heading comprises:
determining the width of the object by determining, based on longitudinal and lateral positions of the first top-view point and longitudinal and lateral positions of the second top-view point, a length of a first side of the object; and
determining the length of the object by determining, based on the longitudinal and lateral positions of the first top-view point and longitudinal and lateral positions of the third top-view point, a length of a second side of the object.

16. The object recognition method of claim 13, further comprising:
displaying a top-view image representing a position, relative to the vehicle, of the object, wherein the top-view image is based on a longitudinal position and a lateral position of the first top-view point, a longitudinal position and a lateral position of the second top-view point, and a longitudinal position and a lateral position of the third top-view point.

17. The object recognition method of claim 12, wherein the tracking of the position of the object comprises:
repeatedly performing, for each frame of the at least one image, processes of:
the obtaining of the at least one image,
the determining of the camera object box,
the determining of the first point, the second point, and the third point, and
the determining of at least one of the length, the width, or the heading; and
tracking the position of the object based on at least one of the length, the width, or the heading in each frame of the at least one image.

18. The object recognition method of claim 12, further comprising:
obtaining, via a light detection and ranging (LIDAR) device, a LIDAR object box that surrounds the object image, wherein the LIDAR object box is a three-dimensional hexahedron box, wherein the LIDAR object box comprises four top vertices and four bottom vertices, wherein the four bottom vertices of the LIDAR object box are closer, to the ground, than the four top vertices of the LIDAR object box, wherein the four bottom vertices of the LIDAR object box comprise:
a first vertex that is closest, among the four bottom vertices, to the vehicle, and
a second vertex and a third vertex that are on both sides of the first vertex, wherein the second vertex is closer, between the second vertex and the third vertex, to the vehicle; and
training the model based on:
inputting, as training data for the first point, a point obtained by projecting, into the at least one image of the object, the first vertex;
inputting, as training data for the second point, a point obtained by projecting, into the at least one image of the object, the second vertex; and
inputting, as training data for the third point, a point obtained by projecting, into the at least one image of the object, the third vertex.

19. The object recognition method of claim 12, wherein the determining of the camera object box comprises determining, from each of a plurality of frames of the at least one image, the camera object box, wherein the first point, the second point, and the third point are determined from each of the camera object boxes in the plurality of frames, and
wherein the method further comprises:
determining, based on a difference between a first position in a first frame of the plurality of frames and a second position in a second frame of the plurality of frames, a speed of the object in the second frame, wherein the first position is at least one of the first point, the second point, or the third point in the first frame, wherein the second position is at least one of the first point, the second point, or the third point in the second frame, and wherein the second frame occurs later than the first frame in the at least one image.

20. The object recognition method of claim 12, wherein the determining of the camera object box comprises determining, from each of a plurality of frames of the at least one image, the camera object box, wherein the first point, the second point, and the third point are determined from each of the camera object boxes in the plurality of frames, and
wherein the method further comprises:
determining, based on a difference between a first position in a first frame of the plurality of frames and a second position in a second frame of the plurality of frames, a traveling direction of the object, wherein the first position is at least one of the first point, the second point, or the third point in the first frame, wherein the second position is at least one of the first point, the second point, or the third point in the second frame, and wherein the second frame occurs later than the first frame in the at least one image.

21. The object recognition method of claim 12, wherein the determining of the camera object box comprises determining, from each of a plurality of frames of the at least one image, the camera object box, wherein the first point, the second point, and the third point are determined from each of the camera object boxes in the plurality of frames, and
wherein the method further comprises:
determining a speed of the object by comparing the first point in a first frame of the plurality of frames with the first point in a second frame of the plurality of frames, wherein the second frame occurs later than the first frame, and
wherein a first portion, of the object, corresponding to the first point in the first frame coincides with a second portion, of the object, corresponding to the first point in the second frame.

22. The object recognition method of claim 12, further comprising:
modeling, based on performing regression, a relationship between:
input data comprising information about the camera object box, and
output data comprising the first point, the second point, and the third point.
